(19) United States
(12) Patent Application Publication
(10) Pub. No.: US 2004/0028025 A1
(43) Pub. Date: Feb. 12, 2004

(54) System and method for providing a two-way audio communication via a web browser

(76) Inventor: Fen-Man Chang, Hsin-Chu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/212,175

(22) Filed: Aug. 6, 2002

(51) Int. Cl. H04L 12/66

(52) U.S. Cl. 370/352; 379/900

(57) ABSTRACT

The present invention provides a system and method capable of implementing a two-way audio communication via a web browser on the IP-based web environment. When a web browser linking to a web server provides a request for transmitting audio data to the web server, the web server will send an ACK/or NAK command responding to the request based upon a current status itself to the web browser. When the ACK command is sent to the web browser, a plug-in program is then transmitted to the web browser, and thereby starting a two-way audio communication therebetween. Then, voice information from a user using the web browser is periodically recorded to an audio file by the plug-in program and transmitted to the web server, and played by a sound player integrated with the web server. The web server then sends audio data to the web browser in response to the voice information.

### BACKGROUND OF THE INVENTION

1. Field of the Invention

The present invention is directed for audio communication on the web environment, and more particularly to a system and method capable of providing a two-way audio communication between two parties via a web browser.

2. Description of the Prior Art

Networking technology has developed a large network of networks, referred to as the Internet, which interconnects millions of computers around the world. The Internet allows the transfer of data between any number of computer systems connected to the Internet using the Transmission Control Protocol/Internet Protocol (TCP/IP). Computers responding to service requests from other computers, via the Internet, are commonly referred to as servers, and computers that initiate requests for service from a server are referred to as clients.

The Internet has become very popular in part due to the World Wide Web (WWW), which is a network of links to hypertext documents operating within the Internet. These hypertext documents are referred to as either web documents, web page, or hypertext documents. Web documents are embedded with directly accessible connections or links to other documents, which create a non-linear way of reading the document. The links are embedded in web documents as a phrase of text or an image, which can be selected and activated by a computer user. Information about the web documents are controlled and provided by web servers. At the user's end, a web client takes the user's requests and passes them on to the web server.

The web documents are written with a high level programming language referred to as the Hypertext Markup Language (HTML). Commands of the HTML, popularly known as tags, provide a variety of functions including, but not limited to, defining special format and layout information in a web document, embedding images and sound in a web document, and embedding links to other web documents.

In order to access, process, and display a web document, a client uses a set of instructions, referred to the tags available in the HTML. Each browser command in turn points to a procedure of one or more instructions defining the command which, when executed, provide a functionality of the respective command. If the client requires service from the web server, the browser uses the hypertext transfer protocol (HTTP) to communicate with the server.

In recent years, the Internet has also become an important and increasingly accepted tool for disseminating business information and promoting products as well as providing support to business customers. Use of the Internet and, in particular, the Worldwide Web has become pervasive in the industrialized world. Consequently, the importance of the Worldwide Web as a business communication tool has been recognized. While its importance is recognized, the electronic information provided by many companies on the Worldwide Web is static and designed to appeal to the widest audience. It is therefore neither adequate nor designed to respond to the specific needs of individuals. In order to obtain the breadth of information most individuals require, it is generally necessary to call the business and verbally request specific information. This process is inefficient because the caller must explain to the business contact what information is viewed, as well as what further particulars are required. This inefficiency has been recognized as a drawback for some time. Consequently, facilities have been developed to permit individuals browsing the Worldwide Web to place voice calls from web pages. Such facilities are commonly called “voice buttons”.

Lucent Technologies® have also been developed methods and apparatus for integrating Worldwide Web pages and 800 call centers to permit browsers of a Wordwide Web page to launch a Voice over IP or a voice terminal connection to 800 call centers while providing an agent at the call center receiving the call with a data terminal screen “POP” (point of presence) of the same page the browser is observing. The agent is therefore visually attuned to the browser's position and enable to quickly and efficiently answer questions or close transactions.

However, this prior audio communication method utilizes the complicated Voice over IP (VoIP) technology, which is a kind of point-to-point audio communication during which the web server can not transmit video/audio data to other browsers until the audio communication is closed. Moreover, complicated communication protocols are required for VoIP, and there would have been the problem of compatibility between the server and the user's browser. Therefore, it is very inconvenient for a business company to disseminate its business information and promoting its products, and also inconvenient for a client to get particulars the product he/she is interested in.

Accordingly, it is an intention to provide a system and method capable of providing a two-way audio communication on the web environment, which can follow client/server architecture using the Internet Protocol (IP) and do not need to utilize the complicated VoIP technology.

### SUMMARY OF THE INVENTION

It is one objective of the present invention to provide a system and method for providing a two-way audio communication via a web browser, which provides an individual two-way audio communication between a web browser and a web server under a demand of the web browser. Therefore, it is not influenced for transmitting video/audio data from the web server to other web browsers at the same time.

It is another objective of the present invention to provide a system and method for providing a two-way audio communication between a web browser and a web server, which follows client/server architecture, the web browser does not need to prepare any specific tool for communication with the web server. Therefore, there is no compatibility problem exists.

It is a further objective of the present invention to provide a system and method for providing a two-way audio communication via a web browser, which can be adopted by a network camera having a built-in web server and integrated with a sound player. Thus, a user can use his web browser to see/hear the viewer of the network camera and has a chance to record his/her sound and play the sound at the network camera's end so as to obtain a purpose of a two-way audio communication between two parties.

It is still a further objective of the present invention to provide a system and method for providing a two-way audio communication via a web browser, which can be adopted by a network camera and therefore applied to an Internet shopping.

In order to achieve the above objectives of this invention, the present invention provides a system and method for providing a two-way audio communication via a web browser. When a web browser links to a web server of the present invention, the web server transmits a web page thereof to the web browser, and the content of the web page is played via a sound card integrated with the web browser. When a user sends a request command for transmitting audio data to a web server through the web browser. The web server sends an ACK/or NAK command based upon a current status thereof to the web browser in response to the request command, wherein the ACK command represents acceptance of the request command, and the NAK command represents refusal of the request command. When the ACK command is sent to the web browser, a plug-in program is then transmitted to the web browser from the web server and thereby starting a two-way audio communication therebetween. Voice information from the user is periodically recorded to an audio file by the plug-in program and sent to the web server through the web browser. Then, the audio file is played via a sound player integrated with the web server. The web server also sends audio data to the web browser in response to the voice information of the user, and the audio data is played via a sound card integrated with the web browser. The two-way audio communication is continued until the web browser sends a stop command to stop the two-way audio communication or the web server sends a terminate command to terminate the two-way audio communication. The present system and method follow client/server architecture, therefore the web browser does not need to prepare any specific tool for communication with the web server. Furthermore, the present method provides an individual two-way audio communication between the web server and the web browser. Thus, it is not influenced for transmitting video/audio data from the web server to other web browser at the same time.

### BRIEF DESCRIPTION OF THE DRAWINGS

The objectives and features of the present invention as well as advantages thereof will become apparent from the following detailed description, considered in conjunction with the accompanying drawings.

FIG. 1 is a schematic functional block diagram of a networking system of the present invention according to one preferred embodiment;

FIG. 2 is a functional block diagram of the present method implemented by the networking system of FIG. 1; and

FIG. 3A to FIG. 3C is a flow diagram of FIG. 2 in a web server's view.

### DESCRIPTION OF THE PREFERRED EMBODIMENTS

The present invention provides a method for providing a two-way audio communication via a web browser, which follows client/server architecture utilizing Internet protocol (IP protocol), and utilizes a standard web server and standard web browser such as, for example the Netscape Navigator and the Microsoft Explorer. Therefore, the present method can provide an individual two-way audio communication between a web server and a web browser, while does not influence other web browsers linking to the web server to browse the content of the web page thereof at the same time. For the present invention, in general case, many web browsers can link to the web server at the same time, then the web server transmits the content of the web page itself, for example text, graphic, video and audio forms, to each web browser linking therewith. The two-way audio communication happens only on the demand of one web browser linking therewith. The two-way audio communication between the web server and the web browser is a kind of individual two-way audio communication, during which it is not influenced for other web browsers to link to the web server and observing the content of the web page thereof.

The present invention also provides a networking system capable of providing a two-way audio communication between two parties via a web browser, which can be adopted by a networking camera having a built-in web server that a user can use his/her web browser to see/hear the viewer of the networking camera. A sound player integrated with the web server let the user has a chance to record his/her sound and play the sound at the networking camera's end. Thus, it can apply to some applications, for example, Internet shopping.

The present invention will be described in detail in accordance with preferred embodiments with reference to accompanying drawings.

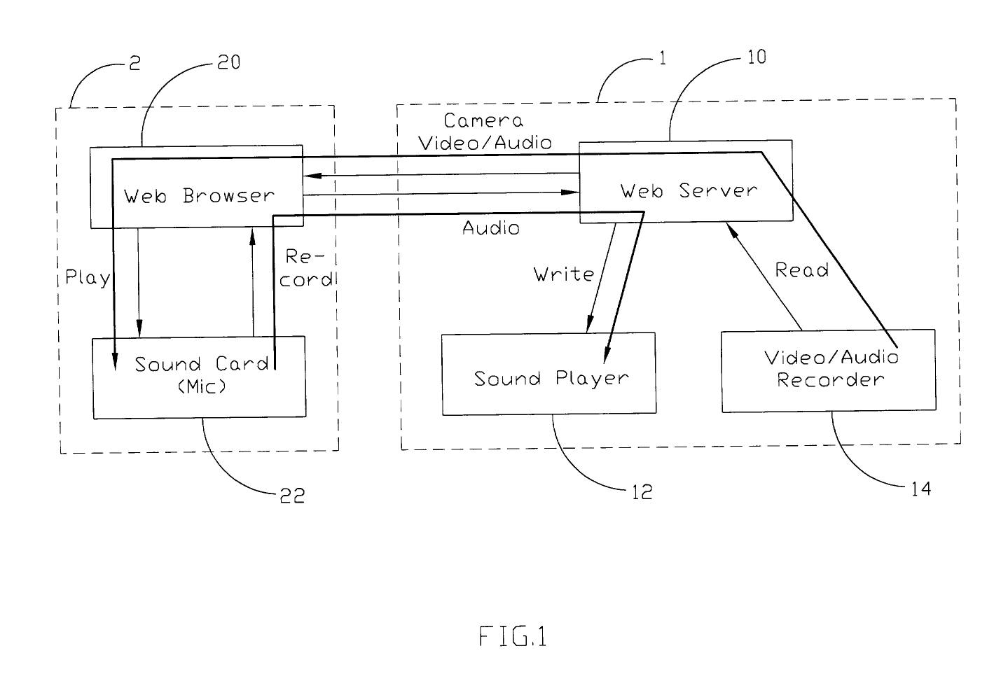

Referring to FIG. 1, which is a schematic functional block diagram of one preferred embodiment of the present networking system adopted by a networking camera. In the preferred embodiment, the networking system comprises a networking camera 1 and a user interface 2 such as, for example a personal computer, a workstation and a personal digital assistant. The networking camera 1 includes a web server 10, a sound player 12 and a video/audio recorder 14. The sound player 12 has its own digital signal processor (DSP) and it does need to directly process audio data. The user interface 2 includes a web browser 20, a sound card 22 and a speaker (not shown). As described above, the web server 10 and the web browser 20 are standard servers and browsers utilized on the IP-based web environment. Once the web browser 20 links to the web server 10, the web server 10 will transmit a web page itself to the web browser 20 for a user operating the user interface 2 to see/hear the content of the web page. That is, the web server 10 can transmit video/audio data concerning the content of the web page reading from the video/audio recorder 14 to the web browser 20 and then played by the sound card 22. However, when the web browser 20 sends a request for transmitting audio data to the web server 10, the web server 10 will send an acceptance/or rejection command based upon a current status itself to the web browser 20 in response to the request. For example, the web server 10 maybe only allow one requester exits at one time. When the acceptance command is sent to the web browser 20, a plug-in program is then transmitted to the web browser 20 from the web server 10, thereby starting a two-way audio communication therebetween. Then, voice information coming from a user operating the user interface 2 through the speaker (not shown) is periodically recorded to an audio file by the plug-in program and transmitted to the web server 10 through the web browser 20, and then played via the sound player 12. The audio file can be a wave file. It is preferable that the file name of the audio file contains time information in order that the web server 10 can judge whether a coming audio file is older or newer than a previous played one directly by the file name, and whether should discard it. Furthermore, when the acceptance command is sent out, a keep-alive timer can be set for periodically transmitting one audio file to the web server 10. The web server 10 also can send audio data to the web browser 20 in response to the voice information of the user, and playing the audio data via the sound card 22. The keep-alive timer defines a period of time, which is the maximum time that the web server 10 can receive an audio file, including the record time by the web browser 20, processing time by the web browser 20 and the web server 10 and the transmission time. When the web server 10 does not receive an audio file from the web browser 20 within the period of time set by the keep-alive timer, the web server 10 would think the web browser 20 is dead, and then forcing to terminate the two-way audio communication therebetween. The two-way audio communication can be closed under the following conditions: 1) by the web browser 20 sending a stop command to stop the two-way audio communication; 2) by the web server 10 sending a terminate command to terminate the two-way audio communication; and 3) the keep-alive timer is timeout.

In accordance with the foregoing, the networking camera 1 can be applied to the application of the Internet shopping. The user can see the viewer of the networking camera 1 through the web browser 20. When the user is interested in a certain product, and desiring to get particulars of this product, he/she can send a query concerning this product to a service man at the networking camera's end, and conducting a two-way audio communication with the service man. Furthermore, since the two-way audio communication between the web server 10 and the web browser 20 is independent, the other browsers also can link to the web server 10, and observing the viewer of the networking camera 1 at the same time.

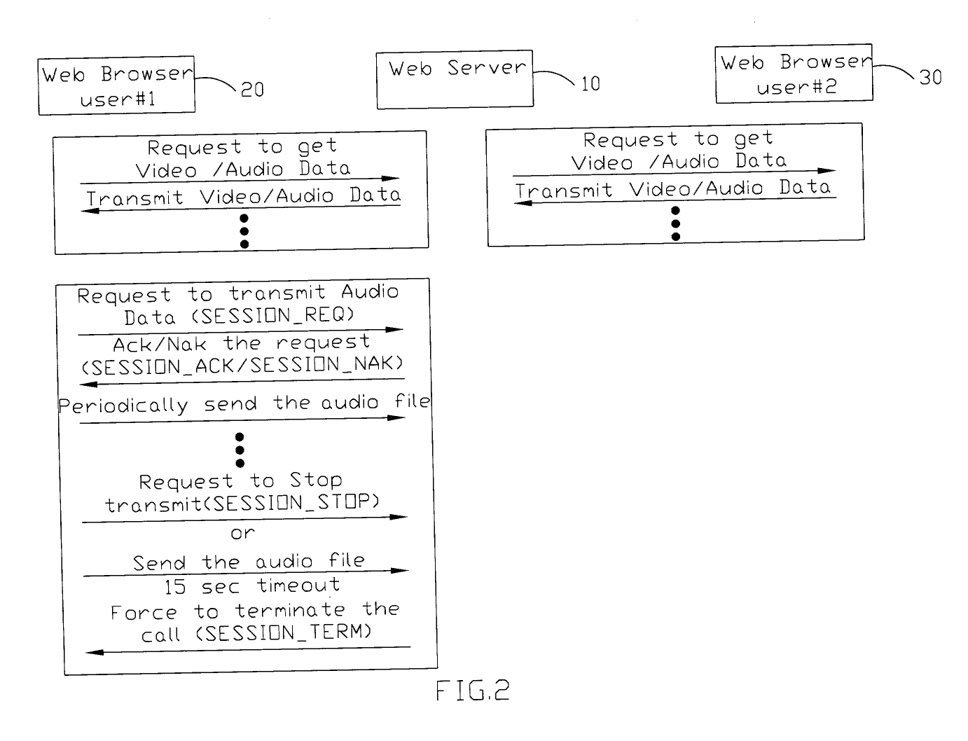

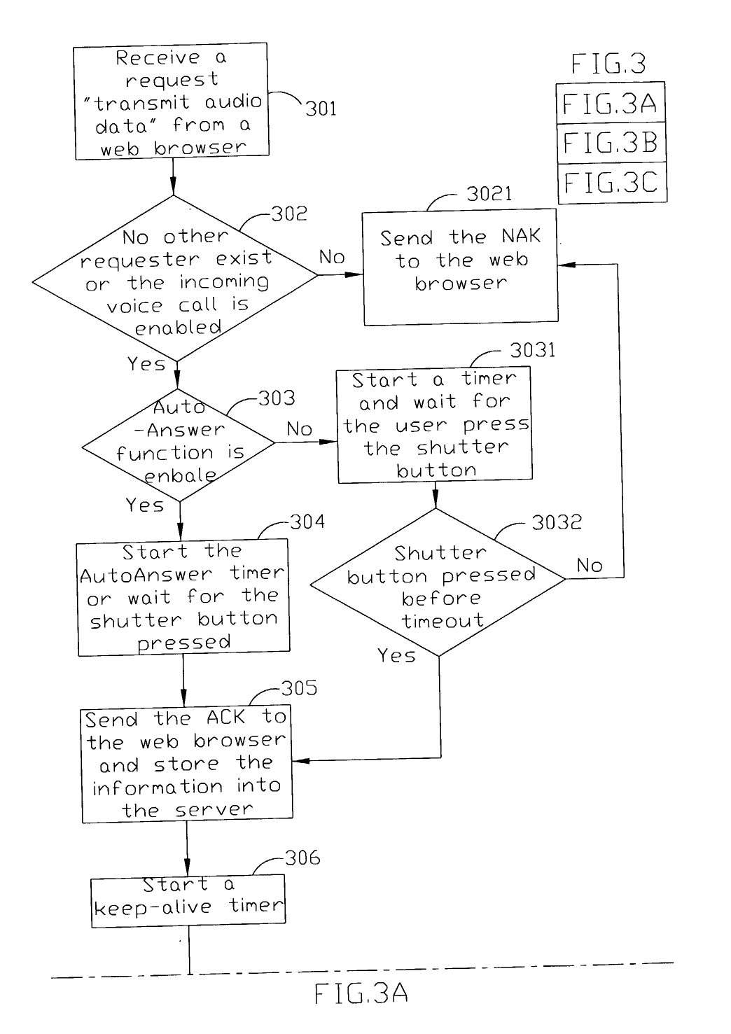

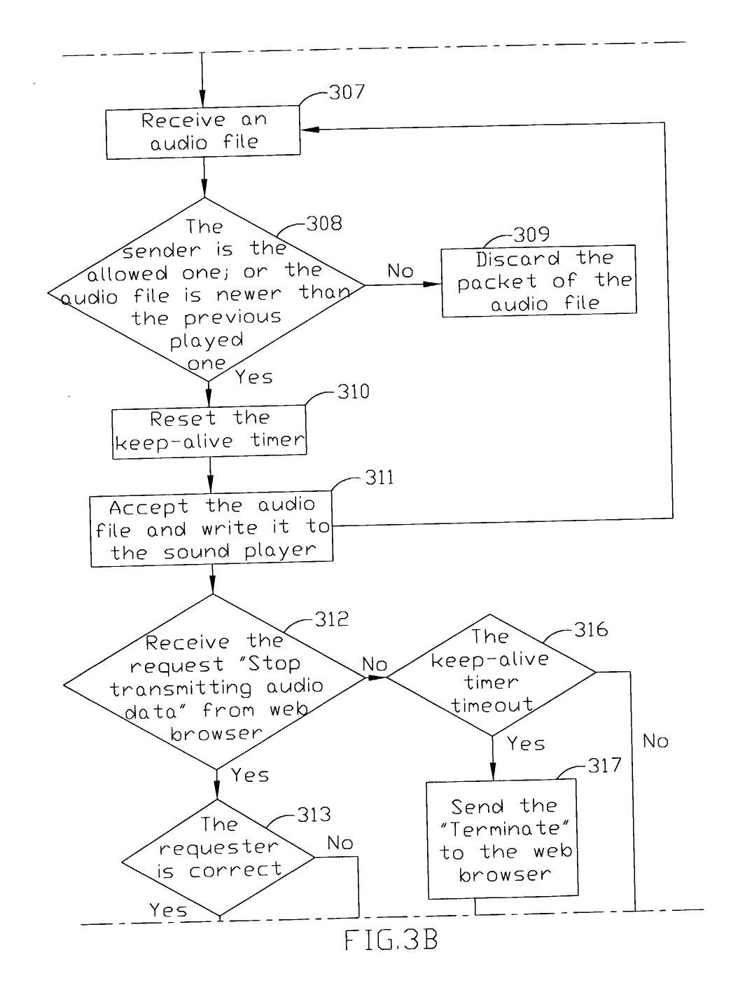

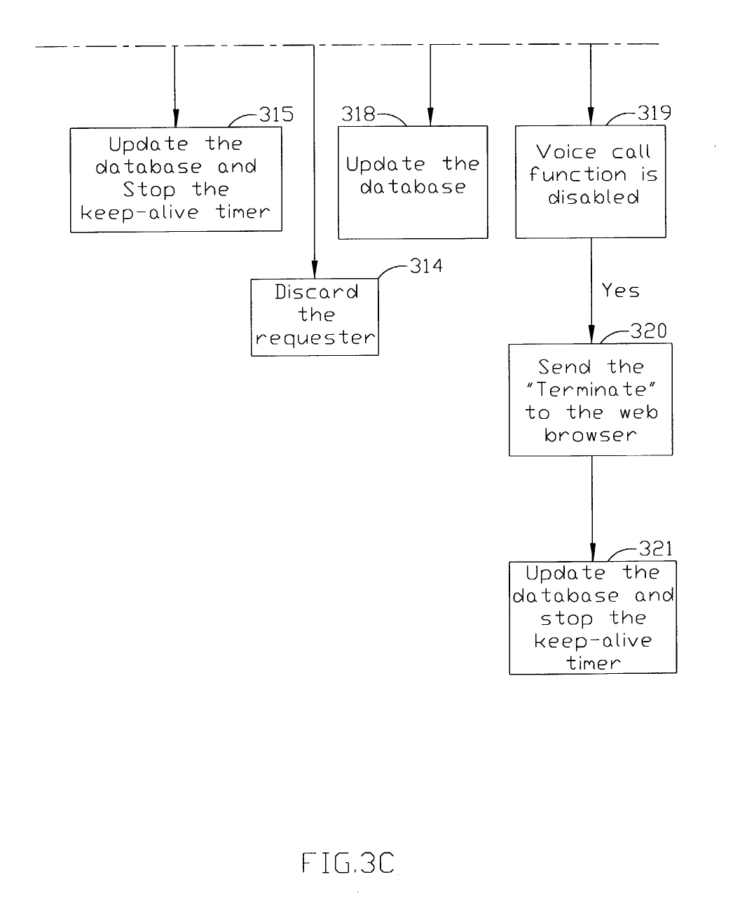

FIG. 2 is a schematic functional block diagram of the present method according to one preferred embodiment. The networking system of FIG. 1 preferably implements this method. FIG. 3A to FIG. 3C is a flow diagram of the preferred embodiment of FIG. 2 in the web server's view. Referring to FIG. 2, in general case, many users can link to the web server 10 and browsing a web page provided by the web server 10 at the same time. For example, user#1 and user #2 can respectively use the web browsers 20 and 30 linking to the web server 10 at the same time, then the web server 10 can transmit the content of the web page itself such as, for example text, graphic, video and audio form, to the web browsers 20 and 30. Once, the web browser 20 transmits a request to transmit audio data, for example, a request command “SESSION_REQ”, to the web server 10, the web server 10 will send an ACK/or NAK command, “SESSION_ACK”/or “SESSION_NAK” based upon the current status itself to the web browser 20 in response to the request, thereby determining whether starting a two-way audio communication between the web server 10 and the web browser 20. The ACK command represents acceptance of the request from the browser 20 and the NAK command represents rejection of the request from the browser 20. However, it is not influenced for the transmission of video/audio data from the web server 10 to the web browser 30 whether the two-way audio communication between the web server 10 and the web browser 20 is started.

The two-way communication between the web server 10 and the web browser 20 will be described in detail with reference to the flow diagram of FIG. 3A to FIG. 3C. That is, when the user#1 desires to conduct a two-way audio communication with an individual at the web server's end, through the web browser 20, firstly, at step 301, the web server 10 receives a request “transmit audio data”, for example, the request command “SESSION_REQ”, from the web browser 20, to request establish a call. Alternately, the request “transmit audio data” can be sent to the web server 10 in a form of voice call. Following, at step 302, the web server 10 judges if no other requester exist or the incoming voice call is enabled. If it is yes, go to step 303, judging whether an auto-answer function of the web server 10 is enabled. If it is yes, go to step 304, start an auto-answer timer or wait for a shutter button pressed at the user#1 end. Then, go to step 305, send an ACK command “SEESION_ACK” to the web browser 20 to accept the call, and storing the information into the web server 10. In the preferred embodiment, the web server 10 sends the ACK command upon there is no other requester existing. However, the web server 10 also can receive more than one requester at the same time, depending on the power of the central unit processor of the web server 10. After that, the web server 10 transmits a plug-in program to the web browser 20 to start a two-way audio communication therebetween. And, go to step 306, start a keep-alive timer, for example, setting about 15 seconds, for receiving an audio file from the web browser 20. Then, go to step 307, the voice information from the user#1 is periodically recorded to an audio file by the plug-in program and transmitted to the web server 10 during the whole call. The audio file is preferably a wave file having a file name containing time information. Then, go to step 308, judging whether the sender is the allowed one having sent the request to establish the call or the audio file is newer than a previous played one. If it is not, go to step 309, discard the packet of the audio file. If it is yes, go to step 310, reset the keep-alive timer for counting the coming time of a next audio file. And, go to step 311, accept the audio file and write it into the sound player 12, thus, the audio file can be played via the sound player 12. The web server 10 then can send audio data to the web browser 20 in response to the voice information from the user# 1, and played via the sound card 22.

The two-way audio communication between the web server 10 and the web browser 20 is continued until at step 312 the user#1 sends a request “stop transmitting audio data”, for example, a stop command “SESSION_STOP”, to the web server 10 to stop the call. If it is yes, go to step 313, judging whether the requester is correct. If it is not, go to step 314 discard the requester. If it is yes, go to step 315 update the database of the web server 10 and stop the keep-alive timer. However, the two-way audio communication may be terminated by some abnomal cases. For example, at step 316, if the keep-alive timer is timeout, the web server 10 will think the web browser 20 is dead. The web server 10 will send a terminate command, for example, “SESSION_TERM” to the web browser 20 to force to terminate the call (see step 317), and update the database (see step 318). One the other abnormal case to force to terminate the call is the service of the web server 10 is closed by the administrator itself, for example, at step 319, the voice call function of the web server 10 may be disabled by the administrator itself. If it is yes, the web server 10 will send the terminate command with a result code to the web browser 20 to force to terminate the call (see step 320), and update the database and stop the keep-alive timer (see step 321). It is preferable to send the terminate command with the result code having information concerning why terminate the call.

Referring to FIG. 3A again, at step 302 judging whether any other requester having existed or the incoming voice call having been enabled. If it is not, send a NAK command, for example, “SESSION_NAK”, to the web browser 20 to reject the call. It is preferable to send the NAK command with a result code having information concerning why the call is rejected, such as server busy representing “already one requester exist”, service closed representing “the incoming voice function is disable” and no answer representing “web server does not answer the call”. Besides, at step 303

judging whether an auto-answer function of the web server 10 is enabled. If it is not, go to step 3031, start a timer, for example, about 15 second, and wait for the user #1 press the shutter button displayed on the web page he/she is browsing. Then, go to step 3032, judging whether the shutter button is pressed before timeout. If it is yes, go to step 305 send the ACK command to the web browser 20 and store the information into the web server 10. Thereafter, step 306 to step 321 follows on. At step 3032, if it is not, go to step 3021 send the NAK command with a result code to the web browser 20 to reject the call.

In the preferred embodiment of FIG. 3A to FIG. 3C, the request command, ACK command, NAK command, stop command and terminate command and their result codes are encapsulated at the HTTP protocol (Hypertext Transmission Protocol). Moreover, the present invention adopts the out-of-band signaling method to transmit the call control message and data message. That is to say, the request command, ACK command, NAK command, stop command and terminate command are transmitted at a control link, and the audio files are transmitted at a data link. Therefore, there will be only one call control session to transmit the call control message and multiple data sessions to transmit the audio data during the whole call, i.e. one audio file one data session. It will help the web server 10 to easily send out the terminate message to terminate the call when needed.

Although the preferred embodiment illustrates a two-way audio communication between the web server 10 and the web browser 20, the present invention is not limited herein. The present invention also can be adopted in a two-way video communication between the web server 10 and the web browser 20. For example, the web browser 20 can transmit a request command for transmitting video data to the web server 10. When the web server 10 sends an ACK command in response to the request command, the web browser 20 would periodically transmits a video file, e.g. Motion.JPEG, to the web server 20, and then being displayed via a video player integrated with the web server 10.

The embodiments are only used to illustrate the present invention, not intended to limit the scope thereof. Many modifications of the embodiments can be made without departing from the spirit of the present invention.

What is claimed is:

1. A method for providing a two-way audio communication via a web browser, comprising:
providing a request command for transmitting audio data to a web server from a user through a web browser;
sending an ACK/or NAK command responding to said request command to said web browser from said web server based upon a current status itself, wherein said ACK command represents acceptance of said request command, and said NAK command represents refusal of said request command;
transmitting a plug-in program to said web browser from said web server and thereby starting a two-way audio communication therebetween when said ACK command is sent to said web browser;
periodically recording voice information from said user to an audio file by said plug-in program and sending said audio file to said web server through said web browser, and playing said audio file via a sound player integrated with said web server; and
sending audio data to said web browser from said web server in response to the voice information of said user, and playing said audio data via a sound card integrated with said web browser, said two-way audio communication being continued until said web browser sends a stop command to stop said two-way audio communication or said web server sends a terminate command to terminate said two-way audio communication.

2. The method of claim 1, further comprising starting a keep-alive timer for periodically transmitting one said audio file once upon said ACK command is sent to said web browser.

3. The method of claim 2, wherein said terminate command with a result code corresponding to timeout of said keep-alive timer is sent out from said web server when said keep-alive timer is timeout.

4. The method of claim 1, wherein said terminate command with a result code corresponding to service closed is sent out from said web server when said web server is disabled by an administrator itself.

5. The method of claim 1, wherein said ACK command is sent out when there is no other previous requester exists.

6. The method of claim 1, wherein said web server sends said ACK command to said web browser depending on requesters that the central processing unit of the web server can handle.

7. The method of claim 1, wherein said NAK command with a result code is sent out, said result code corresponding to refusal information including server busy, service closed, no answer and time out.

8. The method of claim 1, wherein said request command, ACK command, NAK command, stop command and terminate command are encapsulated at Hypertext Transfer protocol.

9. The method of claim 1, wherein the file name of said audio file contains time information.

10. The method of claim 9, wherein when said audio file is older than a previous played one, said audio file is discarded.

11. The method of claim 9, wherein said audio file is a wave file having a file name containing time information.

12. The method of claim 11, wherein when said audio file is older than a previous played one, said audio file is discarded.

13. The method of claim 1, wherein said web browser is selected from the Netscape Navigator and the Microsoft Internet Explorer.

14. The method of claim 1, wherein said request command, ACK command, NAK command, stop command, terminate command and audio files are transmitted by out-of-band signaling method.

15. A networking system capable of providing a two-way audio communication between two parties via a web browser, comprising:
a networking device having a built-in web server, a video/audio recorder and a sound player; and
a user interface including a web browser, a sound card and a speaker;
wherein when said web browser links to said web server, said web server transmits a web page reading from said video/audio recorder to said web browser and the content of said web page is played via said sound card, while when said web browser sends a request for transmitting audio data to said web server, said web server then sends an acceptance/or rejection command based upon a current status itself to said web browser in response to said request, and transmits a plug-in program to said web browser to start a two-way audio communication when said acceptance command is sent out, then voice information from a user operating said user interface through said speaker is periodically recorded to an audio file by said plug-in program and transmitted to said web server through said web browser, and then being played via said sound player, and said web server sends audio data to said web browser in response to said voice information and playing said audio data via said sound card until said web browser sends a stop command to stop said two-way audio communication or said web server sends a terminate command to terminate said two-way audio communication.

16. The networking system of claim 15, wherein said networking device is a networking camera.

17. The networking system of claim 15, wherein said user interface comprises a personal computer, workstation and a personal digital assistant.

18. The networking system of claim 15, wherein said web browser is selected from the Netscape Navigator and the Microsoft Internet Explorer.

19. The networking system of claim 15, wherein said audio file is an audio packet with time information.

20. The networking system of claim 15, wherein said networking device further comprises a video player integrated with said web server, and said web browser can send a request command for transmitting video data to said web server, when said web browser sends said request command to said web server, said web server would send an ACK/or NAK command responding to said request command based upon a current status itself, wherein said ACK command represents acceptance of said request command, and said NAK command represents refusal of said request command, when said web server sends said ACK command, said web browser would periodically transmit a video file to said web server and displaying it via said video player, said web server also sends video information in response to said video data from said web browser, said two-way video communication being continued until said web browser sends a stop command to stop said two-way video communication or said web server sends a terminate command to terminate said two-way video communication.
